(19) United States
(12) Patent Application Publication
(10) Pub. No.: US 2020/0031993 A1
(43) Pub. Date: Jan. 30, 2020

(54) WATER DISPERSIBLE POLYMER FOR USE IN ADDITIVE MANUFACTURING

(71) Applicant: Stratasys, Inc., Eden Prairie, MN (US)

(72) Inventor: William R. Priedeman, JR., Long Lake, MN (US)

(21) Appl. No.: 16/591,198

(22) Filed: Oct. 2, 2019

Related U.S. Application Data
(63) Continuation of application No. 15/737,579, filed on Dec. 18, 2017.

(51) Int. Cl. C08G 63/688; C08G 69/42; B33Y 70/00; C08J 5/00; C08J 11/06; G03G 9/087; B29C 64/40; B33Y 30/00; G03G 15/22; G03G 15/16; B29C 64/106; C08G 18/38; C08G 18/08

(52) U.S. Cl. CPC C08G 63/6886; B29K 2081/00; B33Y 70/00; C08J 5/00; C08J 11/06; G03G 9/08755; G03G 9/08766; B29C 64/40; B33Y 30/00; G03G 15/224; G03G 15/1625; B29C 64/106; C08G 18/3855; C08G 18/0828; C08J 2367/02; C08J 2377/06; C08G 69/42

(57) ABSTRACT

A water dispersible sulfo-polyamide is configured as a filament for use as an extrudable support material in the additive manufacture of a part comprising a non water dispersible polymer. The water dispersible sulfo-polyamide is a reaction product of a sulfo monomer, the water dispersible sulfo-polymer being dispersible in water resulting in separation of the water dispersible polymer from the part comprising the non water dispersible polymer.

### CROSS REFERENCE TO RELATED APPLICATIONS

The present application is a continuation-in-part of U.S. patent application Ser. No. 15/737,579 which is a 371 national stage filing of International Application No. PCT/US2016/038140, filed on Jun. 17, 2016, which is based on and claims the benefit of U.S. provisional patent application Ser. No. 62/182,159, filed Jun. 19, 2015, the contents of all of the above identified applications are hereby incorporated by reference in their entirety.

### BACKGROUND

The present disclosure relates to additive manufacturing systems for printing three-dimensional (3D) parts and support structures. In particular, the present disclosure relates to support and build materials for use in additive manufacturing systems, and methods of using the support and build materials as consumables in additive manufacturing systems to print printed items.

Additive manufacturing, also called 3D printing, is generally a process in which a three-dimensional (3D) part is built by adding material to form a 3D part rather than subtracting material as in traditional machining. Using one or more additive manufacturing techniques, a three-dimensional solid part of virtually any shape can be printed from a digital model of the part by an additive manufacturing system, commonly referred to as a 3D printer. A typical additive manufacturing work flow includes slicing a three-dimensional computer model into thin cross sections defining a series of layers, translating the result into two-dimensional position data, and transmitting the data to a 3D printer which manufactures a three-dimensional structure in an additive build style. Additive manufacturing entails many different approaches to the method of fabrication, including material extrusion, ink jetting, selective laser sintering, powder/binder jetting, electron-beam melting, electrophotographic imaging, and stereolithographic processes.

Additive manufacturing technologies can be used for prototyping (where it has been used for many years) and also for end-use production. For end-use part production, it is desirable to print net-shape parts, or near-net shape parts (i.e., parts that match very closely to the digital image provided as a source data file, and therefore require little or no post-print processing to achieve the desired tolerances for the size and shape for the part).

In a typical extrusion-based additive manufacturing system (e.g., fused deposition modeling systems developed by Stratasys, Inc., Eden Prairie, Minn.), a 3D part may be printed from a digital representation of the printed part by extruding a viscous, flowable thermoplastic or filled thermoplastic material from a print head along toolpaths at a controlled extrusion rate. The extruded flow of material is deposited as a sequence of roads onto a substrate, where it fuses to previously deposited material and solidifies upon a drop in temperature. The print head includes a liquefier which receives a supply of the thermoplastic material in the form of a flexible filament, and a nozzle tip for dispensing molten material. A filament drive mechanism engages the filament such as with a drive wheel and a bearing surface, or pair of toothed-wheels, and feeds the filament into the liquefier where the filament is heated to a molten pool. The solid portion of the filament essentially fills the diameter of the liquefier tube, and acts as a piston on the molten pool provide sufficient pressure to extrude the molten filament material further downstream in the liquefier, from the tip to print a part, to form a continuous flow or toolpath of resin material. The extrusion rate is based on the feed rate of filament into the liquefier, and the filament is advanced at a feed rate calculated to achieve a targeted extrusion rate, such as is disclosed in Comb U.S. Pat. No. 6,547,995.

In a system where the material is deposited in planar layers, the position of the print head relative to the substrate is incremented along an axis (perpendicular to the build plane) after each layer is formed, and the process is then repeated to form a printed part resembling the digital representation. In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited pursuant to the generated geometry during the printing process. The support material adheres to the part material during fabrication and is removable from the completed printed part when the printing process is complete.

A multi-axis additive manufacturing system may be utilized to print 3D parts using fused deposition modeling techniques. The multi-axis system may include a robotic arm movable in three, four, five, six or more degrees of freedom. The multi-axis system may also include a build platform which may be movable in two or more degrees of freedom and independent of the movement of the robotic arm to position the 3D part being built to counteract effects of gravity based upon part geometry. An extruder may be mounted at an end of the robotic arm and may be configured to extrude material with a plurality of flow rates, wherein movement of the robotic arm and the build platform are synchronized with the flow rate of the extruded material to build the 3D part. The multiple axes of motion can utilize complex tool paths for printing 3D parts, including single continuous 3D tool paths for up to an entire part, or multiple 3D tool paths configured to build a single part. Use of 3D tool paths can reduce issues with traditional planar toolpath 3D printing, such as stair-stepping (layer aliasing), seams, the requirement for supports, and the like. Without a requirement to print layers of a 3D part in a single build plane, the geometry of part features may be used to determine the orientation of printing, as well as the routing for all toolpaths. In a multi-axis system, material may be deposited in conformable 3D tool paths laid incrementally upon each other in nonplanar layers to form a printed part resembling the digital representation.

In fabricating printed items by depositing layers of a part material, supporting layers or structures are typically built underneath overhanging portions or in cavities of printed items under construction, which are not supported by the part material itself. A support structure may be built utilizing the same deposition techniques by which the part material is deposited. A host computer generates additional geometry acting as a support structure for the overhanging or free-space segments of the 3D part being formed. The support material adheres to the part material during fabrication, and is removable from the completed printed item when the printing process is complete. Prior art methods of removing support structure have included simply breaking the support structure off of the part material and then smoothing out any residual rough areas, or dissolving away soluble supports using a water-based, alkaline solution. It is desirable to have a support structure that can be removed without special tool or solutions, and with minimal labor. A more easily removable support structure reduces time of manufacture of the part in addition to making the process of removing the support structure easier.

### SUMMARY

An aspect of the present disclosure includes a water dispersible sulfo-polyamide. The water dispersible sulfo-polyamide is configured as a filament for use as an extrudable support material in the additive manufacture of a part comprising a non water dispersible polymer. The water dispersible sulfo-polyamide is a reaction product of a sulfo monomer, the water dispersible sulfo-polymer being dispersible in water resulting in separation of the water dispersible polymer from the part comprising the non water dispersible polymer.

Another aspect of the present disclosure includes a method of additive manufacturing a support structure for use with a part made of a non water dispersible polymer. The support structure comprising a water dispersible sulfo-polyamide comprising a reaction product of a metal sulfur monomer and the water dispersible polymer comprising a polyamide having a glass transition temperature within ±20° C. of the glass transition temperature of the non water dispersible polymer. The method includes separating the non water dispersible polymer from the water dispersible polymer by subjecting the water dispersible polymer to water.

Another aspect of the present disclosure relates to a water dispersible sulfo-polyamide configured as a filament for use as an extrudable consumable material in the additive manufacture of a part comprising a non water dispersible polymer. The water dispersible polymer comprises a reaction product of a metal sulfo monomer, the water dispersible sulfo-polyamide being dispersible in water resulting in separation of the water dispersible polymer from the part comprising the non water dispersible polymer.

Another aspect of the present disclosure relates to a water dispersible sulfo-polyamide configured as a filament for use as an extrudable consumable material in an additive manufacturing system. The water dispersible sulfo-polyamide comprises a condensation reaction product of about an equal mol % of diacid monomers and diamine mononers, the diacid monomers comprising metal sulfo monomer ranging from about 20 mol % to about 50 mol % of the reaction product and diacids in the range of 15 mol % to about 50 mol % and wherein the diamine monomers comprises about 85 mol % and about 100 mol % of aliphatic diamines and about 0 mol % about 15 mol % cyclo-aliphatic diamines.

### Definitions

Unless otherwise specified, the following terms as used herein have the meanings provided below:

The term “polymer” refers to a polymerized molecule having one or more monomer species, and includes homopolymers and copolymers. The term “copolymer” refers to a polymer having two or more monomer species, and includes terpolymers (i.e., copolymers having three monomer species).

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Reference to “a” chemical compound refers to one or more molecules of the chemical compound, rather than being limited to a single molecule of the chemical compound. Furthermore, the one or more molecules may or may not be identical, so long as they fall under the category of the chemical compound. Thus, for example, “a” polyester is interpreted to include one or more polymer molecules of the polyester, where the polymer molecules may or may not be identical (e.g., different molecular weights and/or isomers).

The terms “at least one” and “one or more of” an element are used interchangeably, and have the same meaning that includes a single element and a plurality of the elements, and may also be represented by the suffix “(s)” at the end of the element. For example, “at least one polyester”, “one or more polyesters”, and “polyester(s)” may be used interchangeably and have the same meaning.

The terms “about”, approximately and “substantially” are used herein with respect to measurable values and ranges due to expected variations known to those skilled in the art (e.g., limitations and variability in measurements).

The term “providing”, such as when recited in the claims, is not intended to require any particular delivery or receipt of the provided item. Rather, the term “providing” is merely used to recite items that will be referred to in subsequent elements of the claim(s), for purposes of clarity and ease of readability.

Unless otherwise specified, temperatures referred to herein are based on atmospheric pressure (i.e. one atmosphere).

“Soluble” as referred to herein can be used interchangeably with “disintegrable” and “dissolvable” and relates to materials that disintegrate in a solution or dispersion. Upon disintegration, the water dispersible material can break apart into smaller pieces and/or particles of polymer in the solution or dispersion. Some or all of the water dispersible material may also dissolve into the solution or dispersion upon disintegration.

“Water soluble” as used herein relates to materials that dissolve in tap water that is about neutral pH. It is understood that the pH of tap water can vary depending on the municipality and as such the pH can vary between about 5 and about 9. Although these pH's are slightly basic or slightly acidic, the defining feature of the water soluble materials is that they do not require an acidic or basic solution to disintegrate and can disintegrate in water at about neutral pH, e.g. tap water.

“High temperature build environment” as referred to herein relates to build environments of about 45° C. or greater in additive manufacturing systems.

“Heat deflection temperature” or “heat distortion temperature” (HDT) is the temperature at which a polymer sample deforms under a specified load and is determined by the test procedure outlined in ASTM D648.

“Thermally stable” as referred to herein relates to the material having a heat deflection temperature sometimes referred to as heat distortion temperature (HDT) compatible with the desired build environment such that they do not exceed their thermal-degradation kinetics thresholds.

The term “polyamide” referred to herein relates to both aliphatic and aromatic polyamides. In the case of an aliphatic polyamide such as nylon 6 and nylon 66, the amide link is produced from the condensation reaction of an amino group and a carboxylic acid group wherein water is eliminated. For aromatic polyamides or ‘aramids’ such as Kevlar, an acid chloride is used as a monomer. As used herein, the term “sulfopolyamide” or “sulfo-polyamide” means any polyamide that contains a sulfomonomer.

The term “%” used herein refers to mol %, unless designated otherwise.

### BRIEF DESCRIPTION OF THE DRAWINGS

FIG. 1 is a front view of an extrusion-based additive manufacturing system configured to print printed parts and support structures, where the support structures are printed from a water dispersible material of the present disclosure.

FIG. 2 is a front view of a print head of the extrusion-based additive manufacturing system.

FIG. 3 is an expanded sectional view of a drive mechanism, a liquefier assembly, and a nozzle of the print head for use in the extrusion-based additive manufacturing system.

### DETAILED DESCRIPTION

The present disclosure is directed to a water dispersible sulfo-polyamide material for use in 3D printing. The sulfo-polyamide material can be used for printing sacrificial support structures for 3D parts built in a range of build temperature environments of additive manufacturing systems. It can also be used for layer-wise printing of dissolvable 3D parts. While a sulfo-polyamide material is described herein, the present disclosure can include other species of water dispersible sulfo-polymers.

The water dispersible material of the present disclosure functions as a sacrificial material for an associated part material in additive manufacturing, also referred to as 3D printing applications. A sacrificial support material can be desirable where overhanging features are required, where significant angular slopes exist in the printed items and where it is essential to also preserve delicate features in the printed item, such as small orifices or controlled pore structures, and in some situations, to laterally encase the printed item. Once the item has been printed, the support structure of the water dispersible material is removed to reveal the completed printed item without damaging any of the critical or delicate geometrical features of the printed item. To accomplish this removal, the disclosed material is water dispersible, allowing the support structure to be at least partially and typically completely dissolved away from the printed item. The support structure made be made solely of the water dispersible polymer of this disclosure or other non-dispersible polymers may be incorporated therein as long as the water dispersibility is not substantially affected. In addition, mixtures of other sulfo-polyamides, water-soluble polymers, and non-soluble polymers; additives, fillers, and/or stabilizers may be added to the water dispersible polymer.

The present disclosure also includes the use of the water dispersible sulfo-polyamide for manufacturing a dissolvable part suitable for downstream uses such as sacrificial tooling. A sacrificial tool encompassing the water dispersible sulfo-polyamide may be a dissolvable core type structure on which a part or device is subsequently produced or providing some type of platform for subsequent manufacture of a part or device. Such a process is distinguished from for example a direct additive manufacturing process wherein both the part and the support structure are concurrently printed. For example, a device made of carbon fibers may be formed around the sacrificial tooling made of the water dispersible polymer. Once the carbon fiber device is made, the water dispersible polymer is disintegrated by introducing the water dispersible polymer to water.

The water used to disperse the water dispersible sulfo-polyamide is plain tap or naturally occurring water. Support removal does not require the presence of a basic or acidic environment or heating of the aqueous solution. In addition, the solubility of the water dispersible material is sufficient for use of removal of the supports in an automated process or hands-free manner. Plain tap water typically has an average pH of approximately 7. However, water pH varies greatly, ranging anywhere from having a pH between approximately 5.0 and 9 is also suitable. In any event, the pH of the water does not need to be adjusted to disintegrate the water dispersible sulfo-polyamide. After it disintegrates, the dispersed water soluble polymer solution may be processed by increasing the ionic strength of the solution to precipitate out the water dispersible polymer. The water, with the water soluble polymer removed, may then be recycled for reuse to remove the water dispersible polymer from subsequent parts.

In the embodiment of additive manufacturing, in order to effectively print a support structure in a layer-by-layer manner in coordination with a printed item for example in a fused deposition modeling process, amorphous support materials preferably have a glass transition temperature that is approximately equivalent to or higher than the Tg of the part material. For example, a Tg of ±20 C with a more preferred range of ±15 C of the support material with respect to the Tg of the part material would be considered approximately equivalent and would be compatible. This allows the part and support materials to have similar heat deflection temperatures and other thermal characteristics when printed together as a material pair. For example, similar glass transition and heat deflection temperatures allow the part and support materials to be printed together in the same heated environment while preventing excessive distortions and curling. For semi-crystalline or crystalline support materials, heat deflection temperature is more indicative of acceptable performance than Tg pairing of part and support materials. An example of suitably equivalent heat deflection temperatures are ±20° C. with a more preferred range of ±15° C.

The water dispersible material of the present disclosure may be configured for use with extrusion-based additive manufacturing systems. The material may be amorphous or semi-crystaline, where the level of crystallinity can be manipulated during manufacture of the material via monomer selection.

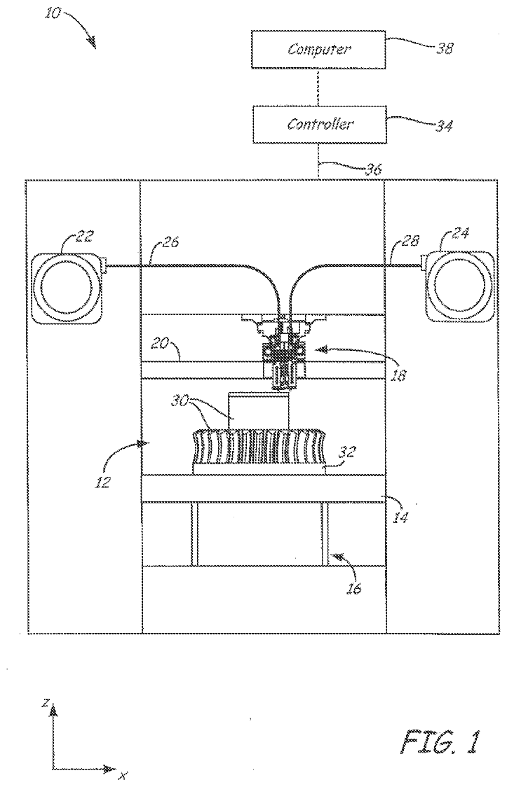

As shown in FIG. 1, system 10 is an example of an extrusion-based additive manufacturing system for printing or otherwise building 3D parts and support structures using a layer-based, additive manufacturing technique, where the support structures may be printed from the water dispersible material of the present disclosure. Suitable extrusion-based additive manufacturing systems for system 10 include fused deposition modeling systems developed by Stratasys, Inc., Eden Prairie, Minn. under the trademark “FDM”.

In the illustrated embodiment, system 10 includes chamber 12, platen 14, platen gantry 16, print head 18, head gantry 20, and consumable assemblies 22 and 24. Chamber 12 is an enclosed environment that contains platen 14 for printing printed parts and support structures. Chamber 12 may be heated (e.g., with circulating heated air) to reduce the rate at which the part and support materials solidify after being extruded and deposited.

Alternatively, the heating may be localized rather than in an entire chamber 12. For example, the deposition region may be heated in a localized manner. Example techniques for locally heating a deposition region include heating platen 14 and/or with directing heat air jets towards platen 14 and/or the printed parts/support structures being printed). The heating anneals the printed layers of the printed parts (and support structures) to partially relieve the residual stresses, thereby reducing curling of the printed parts and support structures.

Platen 14 is a platform on which printed parts and support structures are printed in a layer-by-layer manner. In some embodiments, platen 14 may also include a flexible polymeric film or liner on which the printed parts and support structures are printed. In the shown example, print head 18 is a dual-tip extrusion head configured to receive consumable filaments from consumable assemblies 22 and 24 (e.g., via guide tubes 26 and 28) for printing printed part 30 and support structure 32 on platen 14. Consumable assembly 22 may contain a supply of a part material, such as a high-performance part material, for printing printed part 30 from the part material. Consumable assembly 24 may contain a supply of a support material of the present disclosure for printing support structure 32 from the given support material.

Platen 14 is supported by platen gantry 16, which is a gantry assembly configured to move platen 14 along (or substantially along) a vertical z-axis. Correspondingly, print head 18 is supported by head gantry 20, which is a gantry assembly configured to move print head 18 in (or substantially in) a horizontal x-y plane above chamber 12.

In an alternative embodiment, platen 14 may be configured to move in the horizontal x-y plane within chamber 12, and print head 18 may be configured to move along the z-axis. Other similar arrangements may also be used such that one or both of platen 14 and print head 18 are moveable relative to each other. Platen 14 and print head 18 may also be oriented along different axes. For example, platen 14 may be oriented vertically and print head 18 may print printed part 30 and support structure 32 along the x-axis or the y-axis.

System 10 also includes controller 34, which is one or more control circuits configured to monitor and operate the components of system 10. For example, one or more of the control functions performed by controller 34 can be implemented in hardware, software, firmware, and the like, or a combination thereof. Controller 34 may communicate over communication line 36 with chamber 12 (e.g., with a heating unit for chamber 12), print head 18, and various sensors, calibration devices, display devices, and/or user input devices.

System 12 and/or controller 34 may also communicate with computer 38, which is one or more computer-based systems that communicates with system 12 and/or controller 34, and may be separate from system 12, or alternatively may be an internal component of system 12. Computer 38 includes computer-based hardware, such as data storage devices, processors, memory modules, and the like for generating and storing tool path and related printing instructions. Computer 38 may transmit these instructions to system 10 (e.g., to controller 34) to perform printing operations.

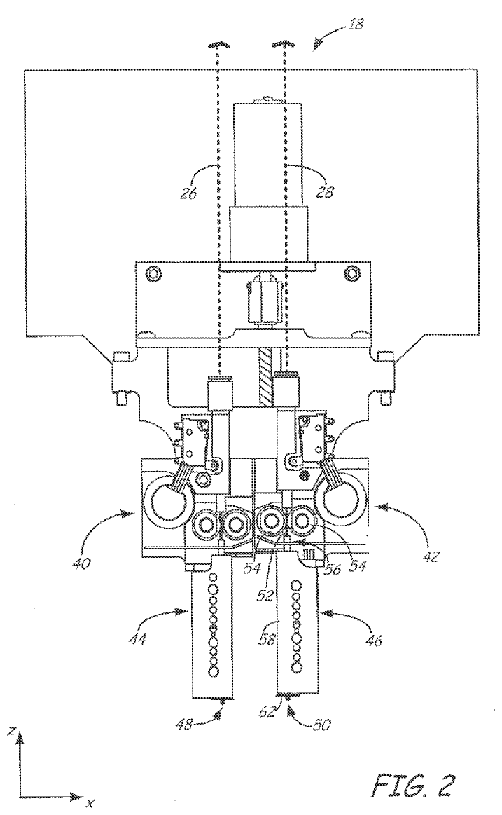

FIG. 2 illustrates a suitable dual-tip device for print head 18, as described in Leavitt, U.S. Pat. No. 7,625,200. Additional examples of suitable devices for print head 18, and the connections between print head 18 and head gantry 20 include those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Leavitt, U.S. Pat. No. 7,625,200; Batchelder et al., U.S. Pat. No. 7,896,209; Comb et al., U.S. Pat. No. 8,153,182; and Swanson et al., U.S. Pat. Nos. 8,419,996 and 8,647,102.

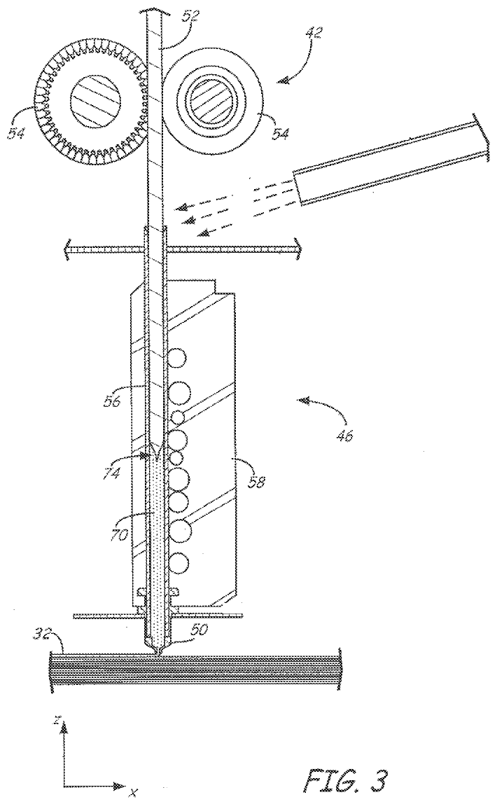

In the shown embodiment, print head 18 includes two drive mechanisms 40 and 42, two liquefier assemblies 44 and 46, and two nozzles 48 and 50, where drive mechanism 40, liquefier assembly 44, and nozzle 48 are for receiving and extruding the part material, and drive mechanism 42, liquefier assembly 46, and nozzle 50 are for receiving and extruding the support material of the present disclosure. In this embodiment the part material and the support material each preferably have a filament geometry for use with print head 18. For example, as shown in FIGS. 2 and 3, the support material may be provided as filament 52. During operation, controller 34 may direct wheels 54 of drive mechanism 42 to selectively draw successive segments filament 52 (of the support material) from consumable assembly 24 (via guide tube 28), and feed filament 52 to liquefier assembly 46. In alternative embodiments, the consumable material may be provided in other geometries or formats adapted for other types of print heads and feed systems, such as powder, liquid, pellet, slug, or ribbon forms.

Liquefier assembly 46 is heated to melt the provided consumable material to form melt 70. Preferred liquefier temperatures will vary depending on the particular polymer composition of the consumable material, and are preferably above the melt processing temperature of the material. The molten portion of the material (i.e., melt 70) forms meniscus 74 around the unmelted portion of filament 52. During an extrusion of melt 70 through nozzle 50, the downward movement of filament 52 functions as a viscosity pump to extrude the support material of melt 70 out of nozzle 50 as extruded roads, to thereby print support structure 32 in a layer-by-layer manner in coordination with the printing of printed part 30. After the print operation is complete, the resulting printed part 30 and support structure 32 may be removed from chamber 12. Support structure 32 may then be sacrificially removed from printed part 30, such as by dissolution or dispersion in tap water.

As mentioned above, the water dispersible material of the present disclosure compositionally comprises a sulfopolymer. The present disclosure partially replaces isophthalic acid (IPA) of the sulfopolymer with a functionalized IPA that leads to water-dispersibility.

It is believed that an important characteristic of the sulfopolymers of this disclosure is “charge density”. Cationic and anionic polymers are characterized by their charge density. An anionic polymer is a polymer containing groups reasonably anticipated to become anionic. Charge density is usually expressed in milliequivalents (meq) of ionic groups per gram of polymer. Suitable charge densities for sulfopolymers of this disclosure are in the approximate range of (0.4 to 0.9 meq/g). Suitable charge densities are also those that for any particular sulfopolymer provide a water dispersibility characteristic to that sulfopolymer. Sulfopolymers with high charge densities are more easily and quickly dispersed in water, lending themselves to faster manufacturing removal. Lower charge densities produce polymers that are resistant to water dispersibility. Higher charge density relating to better dispersibility in water is believed to be also a characteristic of other anionic polymers as anionic polymers are defined herein.

The use of a sodium or lithium salt of isophthalic acid such as 5-sodiosulfoisophthalic acid (5-SSIPA) (CAS #6362-79-4) or derivatives thereof as a monomer in the synthesis of a sulfopolymer has been found to be suitable as a consumable material for use in layer-wise additive manufacturing. In addition, the inclusion of 5-SSIPA as a monomer provides a suitable charge density to that polymer if added in an amount sufficient to provide water dispersibility.

5-SSIPA can be used as a monomer in producing condensation polymers including but not limited to sulfopolyesters, sulfopolyamides, sulfopolyesteramides, sulfopolyurethanes and blends thereof results in sulfopolymers that exhibit water solubility and/or dispersibility. Sulfonation of other polymer categories such as polystyrene, polyvinyl acetate, polyvinyl chloride, polyacrylates, polyvinylidine chloride, polyimides, polyarylsulfones, polycarbonates, including copolymers or admixtures thereof are also contemplated. The use of other sulfonated aromatic diacid or diol monomers in the synthesis of a sulfopolymer is contemplated to be useful as a water dispersible 3D printing material within this disclosure.

Preferably, the polymer contains approximately 5 to 50 mol % sulfoisophthalic monomer, with a more preferred range of approximately 20 to 35 mol % sulfoisophthalic monomer and most preferably approximately 20 to 30 mol % sulfoisophthalic monomer. Examples of the sulfoisophthalic monomer may include but are not limited to sodiosulfoisophthalic monomers.

In one embodiment, polyamides are prepared by employing as one of the reactants a sulfonated aromatic dicarboxylic acid. Suitable sulfonated aromatic dicarboxylic acids include those having the structural formulas

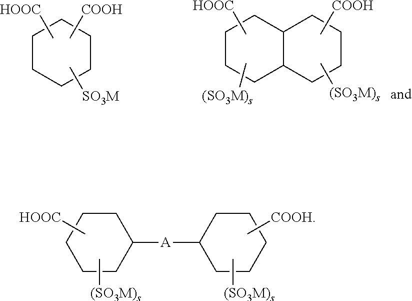

In the above structural formulas M is an alkali metal such potassium, sodium, lithium and cesium; A represents a direct bond or divalent radical selected from the group consisting of —O—, —CH2-CH2-, —O—CH2-CH2-O—, —SO2-, —S—, —CF2-, —C(CH3)2-,

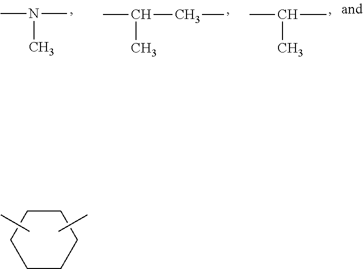

And y and z are 0 or 1, the sum of y and z being at least 1.

It will be understood that, in the above structural formulas, any or all of the hydrogens in the carboxyl groups (—COOH) can be replaced with alkyl groups, usually the lower alkyl groups, and the —OH of the carboxy groups can be replaced by a halogen such as chlorine. Thus, the polyamide: of this disclosure can be prepared by employing the lower alkyl esters and the acid chlorides of the above compounds and/or diacids, diamines and combinations thereof.

The polyamides of this disclosure will contain in their molecular formula recurring structural units of the general structure

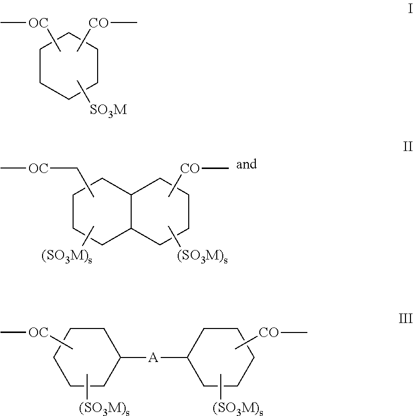

Wherein M, A, y and z are as previously defined.

In carrying out this disclosure the sulfonated aromatic dicarboxylic acid can be employed in varying amounts. It has been determined, however, that amounts sufficient to provide a polyamide-based water dispersible material containing the above recurring structural units in amounts of from about 5 to 50 mole percent, with about 20 to 30 mole percent being preferred, can be employed. In general, the proportions of the respective recurring units in the polyamide-based water dispersible material will be found to be approximately the same as the mole proportions of the reactants.

Examples of sulfonated aromatic dicarboxylic acids that can be employed in carrying out this invention include the following:

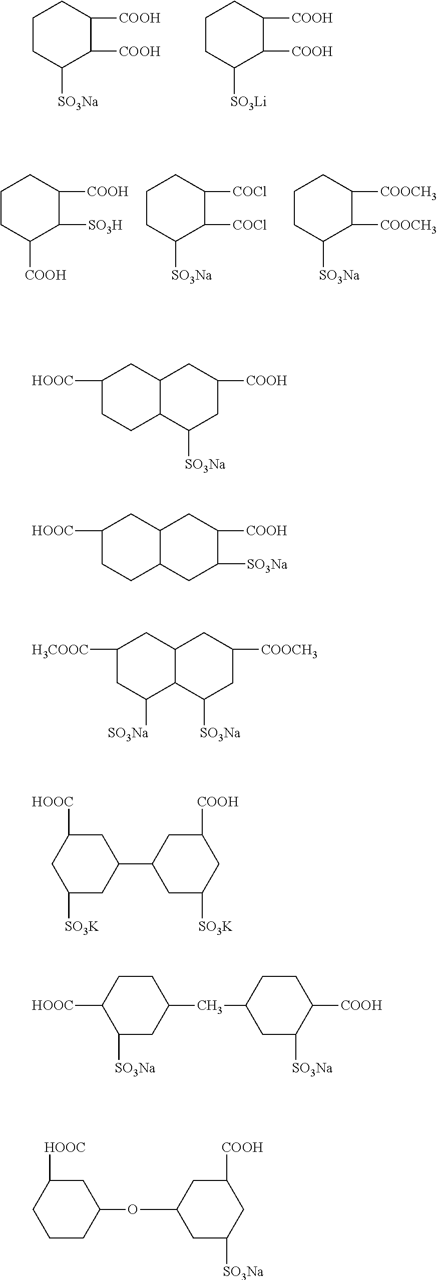

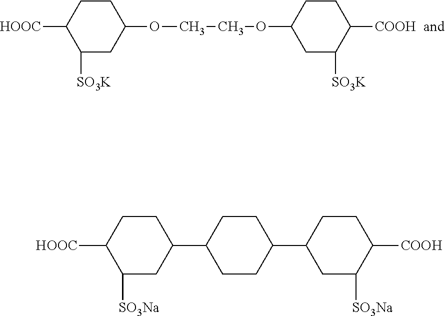

The other reactants employed in this invention are well known polyamide forming compounds and include various amino acids having the general formula

H2N—R—COOH

wherein R is selected from the group consisting of a divalent aliphatic radical, either straight or branched chain; a divalent alicyclic radical; and a divalent aromatic radical. If amino acids are employed, the polyamide will be comprised of, in addition to at least one of the recurring units I, II, and III, recurring units of the general structure

—HN—R1-CO— IV

wherein R is as previously defined.

Also salts of various dicarboxylic acids and diamines represented by the structural formulas

HOOC—R—COOH

and

H2N—R2-N1H2

can be employed in the preparation of the polyamides of this invention. In the above formulas R is selected from the group consisting of divalent aliphatic radicals, either straight or branched chain: divalent alicyclic radicals; and divalent non-sulfonated aromatic radicals. R2 is selected from the group consisting of divalent aliphatic radicals, either straight or branched chain; divalent alicyclic radicals; and divalent aromatic radicals. Polyamides prepared from the above salts will be comprised of, in addition to at least one of the structural units I, II, and III, recurring units of the general structure

—HN—R2-NH—CO—R1-CO— V

wherein R and R are as above defined.

Instead of using the salt of the above defined diamines and dicarboxylic acids, the polyamides can be prepared by a condensation reaction from a mixture of a diamine, as above defined, a dicarboxylic acid, as above defined, and a sulfonated aromatic dicarboxylic acid. Thus, for example, a mixture of the above compounds can be heated in a suitable reaction vessel, in an inert atmosphere, at a temperature of from about 200 C. to 280 C. for about 2 to 4 hours, or longer depending on the viscosity desired of the resulting polyamide. The reaction can be conveniently carried out in aqueous media or in a suitable solvent such as cresol, xylenol, o-hydroxydiphenyl. and the like. It is preferred, however, to employ the salt of the diamine and dicarboxylic acid.

In a preferred method of preparing the polyamide-based water dispersible material, a salt of the sulfonated aromatic dicarboxylic acid and a diamine is first prepared. Suitable diamines for this purpose include any of those set forth hereinabove for use in preparing salts of a diamine and the defined dicarboxylic acid. The salt can be conveniently produced by dissolving substantially equimolar proportions of the diamine and the sulfonated aromatic dicarboxylic acid in water and subsequently pouring the solution into a nonsolvent for the formed salt, such as ethanol, wherein the salt precipitates out.

The diamine-sulfonated aromatic dicarboxylic acid salt is then reacted with (i) an amino acid, as above defined, or (2) a diamine-dicarboxylic acid salt, as above defined to produce the polyamides. Known polyamide forming methods can be employed. It is preferred, however, to prepare a mixture of the above ingredients and heat the mixture in an inert atmosphere at a temperature of from about 230 C. to 260° C. for about 1 hour to 2 hours to form a low molecular weight polymer, a prepolymer. The reaction is carried out in aqueous media or in a solvent such as cresol, xylenol, or o-hydroxydiphenyl. The prepolymer is then heated and stirred, in its molten form, at a temperature of from about 240 C to 300 C. for about 1 hour to 3 hours, or longer to produce a polyamide of desired viscosity. Alternatively, the prepolymer can be solidified and ground to particle size, particles of a cross-sectional diameter of about 0.03 inch or smaller being satisfactory. The particles are subsequently heated in a vacuum or in an inert atmosphere at 10 C. to 50 C below their melting point for about 2 to 4 hours. Under these conditions, the polymer can be built up to a relatively high viscosity.

Amino acids that can be used in carrying out this invention include straight chain aliphatic amino acids having the structural formula wherein n represents an integer of 5 through 10 branched chain aliphatic amino acids of the same range of carbon atoms as the straight chain aliphatic amino acids, alicyclic amino acids, and aromatic amino acids.

Specific examples of amino acids include S-amino-n-valeric acid, G-amino-n-caproic acid, 7-amino-n-heptanoic acid, 1,2-amino-n-dodecanoic acid, 3-methyl-6-aminohexanoic acid, 4,4-dimethyl-7-aminoheptanoic acid 4-ethyl-6-amino-hexanoic acid, 4-aminocyclohexanecarboxylic acid, 3-aminomethylcyclohexanecarboxyllc acid, 4-aminoethylcyclohexanecarboxylic acid, 4-aminomethylcyclohexanecarboxylic acid, 4-carboxypiperidine, ∝-amino-p-toluic acid, ∝-amino-m-toluic acid, 5-aminonorcamphane-2-carboxylic acid, and 5-aminomethylnorcamphane-2-carboxylic acid.

As set forth hereinabove various salts of certain dicarboxylic acids and diamines can be employed as one of the reactants in preparing the polyamides.

Dicarboxylic acids suitable for this purpose include aliphatic dicarboxylic acids containing from 4 to 12 carbon atoms between the carboxyl groups, either straight or branched chains, non-sulfonated aromatic dicarboxylic acids, and alicyclic dicarboxylic acids. The amount of dicarboxylic acid monomer can be varied to obtain a desired Tg or Tg range. For instance, more monomer aliphatic diacid is used to lower the Tg and less monomer aliphatic diacid increases the Tg. Further, the amount of aliphatic diacid monomer can be adjusted to customize the flexibility of the material, where longer carbon chains provide greater flexibility. By way of example, the filament material can include from about 10 mol % to about 60 mol % of the monomer aliphatic diacid.

Specific examples of aliphatic dicarboxylic acids include oxalic acid, dimethylmalonic acid, succinic acid, glutaric acid, adipic acid, 2-methyladipic acid, 3-ethyladipic acid, pimelic acid, azelaic acid, suberic acid, sebacic acid, 3-ethylsebacic acid, and dodecanedioic acid.

Specific examples of alicyclic dicarboxylic acids include 1,1-cyclohexanedicarboxylic acid, 1,2-cyclohexanedicarboxyiic acid, 1,3-cyclohexanedicarboxyllic acid, and 1,4-cyclohexanedicarboxylic acid. Alicyclic dicarboxylic acids can be used to increase the Tg of the material. By way of example, the alicyclic dicarboxylic acids can range from about 15 mol % and about 30 mol % of the total composition. The transisomer of the above acids is preferred; however, the cis isomer or mixtures of the two can be employed if desired. Other suitable alicyclic dicarboxylic acids include norcamphane-2,′5-dicarboxylic acid; norcamphane-2,6-dicarboxylic acid, and

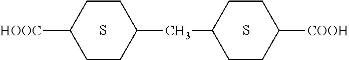

Non-sulfonated aromatic dicarboxylic acids include phthalic acid. isophthalic acid, terephthalic acid, and the halogenated derivatives of these acids. Other suitable aromatic dicarboxylic acids include those acids having the structural formula

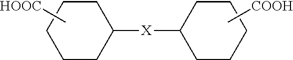

Wherein X can be, for example, a direct bond, —O—, —S—, —SO2-, —CH2-, —CH2-CH2, —CH2-CH2-CH2, —CH2-CH2-CH2-CH2-, —O—C2H4-O—, —C(CH3)2-,

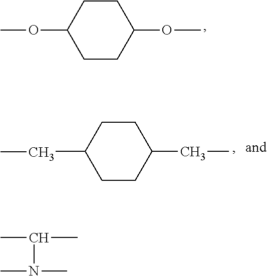

Acids containing one or more ether groups in the molecular chain as represented by ethylenedioxydiacetic acid, 4,4′-oxydibutyric acid, and 3,3′-oxydipropionic acid can be employed.

Suitable diamines for use in preparing the above-mentioned salt include aliphatic diamines containing 4 to 12 carbon atoms between the amino groups, either straight or branched chains, alicyclic diamines, and amines containing one or more aromatic nuclei.

Specific examples of aliphatic diamines include ethylene diamine, tetramethylenediamine, pentamethylenediamine, hexamethylenediamine, octamethylencdiamine, 1,12-diaminododecane, 2,2-dimethyl-1,5-diaminopentane, 3,6-diethyl-1, 8-diaminooctane, 2-methyl-1, 3-diaminopropane, 3-ethyl-1,6-diaminohexane, and 4-butyl-1,10-decamethylenediamine. Diamines containing one or both amino groups on a secondary carbon atom and diamines containing secondary amino groups can also be employed.

Examples of specific alicyclic diamines include 1,2-diaminocyclohexane, 1,3-diaminocyclohexane, 1,4-diaminocyclohexane, 1,1 cyclohexanebis(methylamlne), 1,2 cyclohexanebis(methylamine), 1,3 cyclohexanebls (methylamine), and 1,4 cyclohexanebis(methylamine). These diamines can be used as the transisomer or use mixtures of cis and trans-isomers. Other suitable alicyclic diamines include 2.5 norcamphanediamlne, 2.6 norcamphanediamine, 2,5 norcamphanebis(methylamine), and 2,6-norcamphanebis(methylamine). Diamines containing one or more aromatic nuclei include o-, m-, and p-xylene-∝,∝-diamines, and 3,4′-dl-(aminomethyl)diphenyl.

Diamines containing ether groups such, for example, as 3,3 oxybis(propylamine), 3,3 (ethylenedioxy)bis (propylamine), and 3,3′-(2,2-dimethyltrimethylenedioxy) bis(propylamine) can be employed.

It is understood that the polyamides herein can be prepared by employing, in place of the above-defined acidic compounds, the lower alkyl esters thereof. The phenyl ester can also be employed if desired. Further, the acid chloride of the acidic compound can be employed in preparing polyamides of this invention if desired. This is usually accomplished in the presence of an acid-accepting agent.

In some instances, it can be desirable to heat the sulfonated aromatic dicarboxylic acid with an excess of a diamine, usually about 25 mole percent to 45 mole percent, to provide a diamine that is terminated with amino groups. The dicarboxylic acid is then added in an amount molecularly equivalent to the excess diamine employed and the reaction is completed as above described.

### EXAMPLES

The following examples are included for illustrative purposes only and are not intended to limit the scope of this disclosure.

### Example 1

Table 1 set forth below associated model polymers with a particular Tg, used to make parts using fused desposition modeling technology, and pairs with it water dispersible support polymer types or combinations made under this disclosure having compatible glass transition temperature (Tg) or heat deflection temperature (HDT).

TABLE 1

| | Glass Transition | Heat Deflection |
|---|---|---|
| Part Material/Non-Water | Temperature | Temperature |
| dispersible Polymers | (Tg) ° C. | (HDT) ° C. |
| FDM ™ TPU 92A | NA | 38 |
| (thermoplastic polyurethane | | |
| with a Shore value of 92)¹ | | |
| FDM ™ ABS-M30¹ | 108 | 96 |
| FDM ™ ASA (acrylonitrile | 108 | 98 |
| styrene acrylate)¹ | | |
| FDM ™ Nylon 6¹ | | 93 |
| FDM ™ Nylon 12¹ | | 97 (annealed) |
| | | 75 (unannealed) |
| FDM ™ Nylon 12CF¹ | 41 | 143 |
| Diran ™ (amorphous nylon | 125 | |
| copolyimide blend of PA | | |
| 6I/6T and PA 6,6)¹ | | |
| Crestone ™ (PES composite)¹ | 220 | 215 |
| ULTEM ™ 9085^{1 and 2} | 185 | 153 |
| ULTEM ™ 1010^{1 and 2} | 225 | 216 |
| | Support Structure Water | |
| | Dispersible Polymer Compositions | |
| | tested, having Compatible | |
| | Tgs; mole % of monomers | |
| Monomers | Polyamide | Polyamide |
| Composition One: | | |
| 5-sodiosulphoisophthalic acid | 30 | |
| Terephthalic acid | 35 | |
| Isophthalic acid | 35 | |
| Composition Two: | | |
| Hexamethyldiamine | 100 | |
| Composition Three: | | |
| 4,4′-methylenebis(2- | | 36 |
| methylcyclohexylamine) | | |
| Laurolactam | | 28 |
| Isophthalic acid | | 6 |
| 5-sodiosulphoisophthalic acid | | 30 |

¹polymer filament from Stratasys, Inc. of Eden Prairie, MN, USA
²ULTEM ™ is a registered trademark of SABIC or its affiliates

Table 1 illustrates that the Tg and/or the HDT of the water dispersible sulfo-polyamide material of the present disclosure can be manipulated to be compatible with numerous part materials. The Tg of the part material ranges from about 40° C. (FDM™ Nylon 12 CF) to about 225° C. (Ultem™, 2 1010) and the water dispersible sulfo-polyamide material formulations can be adjust to have a compatible Tg and/or HDT. What is meant by compatible the part material and the water dispersible sulfo-polyamide material have a Tg and/or HDT with ±20° C. of each other.

### Example 2

A water dispersible sulfo-polyamide for use in an extrusion-based additive manufacturing system was formed and made into a consumable filament using the following formulation found in Table 2.

| Component | Mol % |
|---|---|
| FIRST PART | |
| 5-sodiosulfoisophthalic acid (SSIPA) | 20-30 |
| Aliphatic diacid | 15-60 |
| Aromatic diacid | 15-50 |
| SECOND PART | |
| Aliphatic diamine | 85-100 |
| Cyclo-aliphatic diamine | 0-15 |
| OPTIONAL | |
| Lactam | 0-25 |

The SSIPA, aliphatic diacid and aromatic diacid were grouped together to determine a first part of the material. The aliphatic diamine and aromatic diamine were grouped into a second part of the material. The composition of the first part and the second part were determined to have equal mol percents such that the composition has a substantially neutral charge. The lactam is added to the mixture in mol % based upon the total mol percents of the first and second groups.

The lactam is optional, but is typically included in the material to increase the flexibility of the consumable filament of the material. However, the lactam has equal parts of positive and negative charge and therefore does not affect the charge of the material.

Exemplary, but non-limiting, aliphatic diacids include carbon chains ranging from 4 to 12. Exemplary, but non-limiting, aliphatic diacids include adipic acid, sebacic acids, dodecanoic acid and combinations thereof.

Exemplary, but non-limiting, aromatic diacids include carbon chains ranging from 4 to 12. Exemplary, but non-limiting, Exemplary, but non-limiting, aromatic diacids include carbon chains ranging from 4 to 12. Exemplary, but non-limiting, aromatic diacids include isothalic acid, terephthalic acid and combinations thereof.

Exemplary, but non-limiting, aliphatic diamides and cyclo-aliphatic diamines include carbon chains ranging from 4 to 12. Exemplary, but non-limiting, aliphatic diamines includes hexamethylenediamine (HDMA) and exemplary cyclo-aliphatic diamines includes bis-(4-amino-3-methyl-cyclohexyl)-methane (MACM) and para-diaminodicyclohexylmethane (PACM) and combinations thereof.

In some embodiments, lactam is included in the material to increase toughness of the material. The lactam has carbon chains ranging from 4 to 12. Exemplary, but non-limiting, examples of lactam include caprolactam, laurolactum and combinations thereof.

The chosen components and amounts disclosed in Table 2 are combined in a reactor. The reactor is stirred and heated under pressure (up to 300° C. and 300 psig). The temperature and pressure are maintained until the condensation reaction is completed. The product of the condensation reaction is pumped from the reactor, cooled and pelletized. The pelletize material can then be formed into a filament for use in an extrusion-based additive manufacturing system.

Relative to other known water-dispersible materials which utilize alkaline aqueous solutions, the disclosed water dispersible sulfo-polyamide material is removed from a part more quickly in tap water by at least a factor of two.

Although the present disclosure may have been described with reference to preferred embodiments, workers skilled in the art will recognize that changes may be made in form and detail without departing from the scope of the disclosure.

What is claimed:

1. A water dispersible sulfo-polyamide configured as a filament for use as an extrudable support material in the additive manufacture of a part comprising a non water dispersible polymer, wherein the water dispersible sulfo-polyamide is a reaction product of a sulfo monomer, the water dispersible sulfo-polymer being dispersible in water resulting in separation of the water dispersible polymer from the part comprising the non water dispersible polymer.

2. The water dispersible sulfo-polymer of claim 1, wherein the water dispersible sulfo-polymer has a heat deflection temperature within ±20° C. of the heat deflection temperature of the non water dispersible polymer.

3. The water dispersible sulfo-polymer of claim 1, wherein the water dispersible polymer has a glass transition temperature within ±20° C. of the glass transition temperature of the non water dispersible polymer.

4. The water dispersible polymer of claim 1, and further comprising the reaction product of a condensation reaction.

5. The water dispersible polymer of claim 1, and further comprising approximately 18 to 40% metal sulfoisophthalic monomer.

6. The water dispersible polymer of claim 6, and further comprising approximately 20 to 30% metal sulfoisophthalic monomer.

7. The water dispersible polymer of claim 1, wherein the metal sulfo monomer is a sodio sulfo monomer or a lithium sulfo monomer.

8. The water dispersible polymer of claim 3, wherein the water dispersible polymer is characterized by a glass transition temperature of at least approximately 40° C.

9. The water dispersible polymer of claim 1, wherein the water dispersible polymer is substantially amorphous.

10. The water dispersible polymer of claim 1, wherein the water dispersible polymer is at least semi-crystalline.

11. The water dispersible polymer of claim 1, wherein the water dispersible polymer has a charge density of at least about 0.4 meq./g, suitable to exhibit water solubility or water dispersibility without the aid of any other solubility or dispersibility adjuvant.

12. The water dispersible polymer of claim 1, wherein a sulfonated aromatic diacid or diol monomer is used in the synthesis thereof.

13. The water dispersible polymer of claim 1, and further comprising a diacid in a range of about 15 mol % to about 50 mol % on a diamine basis.

14. The water dispersible polymer of claim 1, and further comprising lactam ranging up to about 25 mol % of the total molar basis.

15. A method of additive manufacturing a support structure for use with a part made of a non water dispersible polymer, the method comprising:
the support structure comprising a water dispersible sulfo-polyamide comprising a reaction product of a metal sulfur monomer and the water dispersible polymer comprising a polyamide having a glass transition temperature within ±20° C. of the glass transition temperature of the non water dispersible polymer; and
separating the non water dispersible polymer from the water dispersible polymer by subjecting the water dispersible polymer to water.

16. The method of claim 15 and wherein the method further comprises the reaction product of the metal sulfur monomer and the water dispersible polymer comprises the polymer having a heat deflection temperature within ±20° C. of the heat deflection temperature of the non water dispersible polymer.

17. The method of claim 15, wherein the water dispersible sulfo-polyamide has a charge density of at least approximately 0.4 meq./g, such that the water dispersible sulfo-polyamide is dispersible in water resulting in separation of the water dispersible polymer from the part comprising the non water dispersible polymer.

18. The method of claim 17 wherein the charge density is between approximately 0.4 meq/g and 0.9 meq./g.

19. The method of claim 15, wherein the water dispersible sulfo-polyamide comprises a sulfoisophthalic monomer.

20. The method of claim 19, wherein the water dispersible sulfo-polyamide comprises approximately 18 to 35 mol % sulfoisophthalic monomer on a diacid basis.

21. The method of claim 20, wherein the water dispersible sulfo-polyamide comprises approximately 25 to 35 mol % sulfoisophthalic monomer on a diacid basis.

22. A water dispersible sulfo-polyamide configured as a filament for use as an extrudable consumable material in the additive manufacture of a part comprising:
a non water dispersible polymer, wherein the water dispersible polymer is a reaction product of a metal sulfo monomer, the water dispersible sulfo-polyamide being dispersible in water resulting in separation of the water dispersible polymer from the part comprising the non water dispersible polymer.

23. The water dispersible sulfo-polyamide of claim 22, wherein the water dispersible sulfo-polyamide has a heat deflection temperature within ±20° C. of the heat deflection temperature of the non water dispersible polymer.

24. The water dispersible sulfo-polyamide of claim 22, wherein the water dispersible sulfo-polyamide has a glass transition temperature within ±20° C. of the glass transition temperature of the non water dispersible polymer.

25. The water dispersible sulfo-polyamide of claim 22, wherein the metal sulfo monomer is a sodio sulfo monomer or a lithium sulfo monomer.

26. The water dispersible polymer of claim 22 comprising approximately 18 to 40% sulfoisophthalic monomer.

27. A water dispersible sulfo-polyamide configured as a filament for use as an extrudable consumable material in an additive manufacturing system, the water dispersible sulfo-polyamide comprising a condensation reaction product of:
about an equal mol % of diacid monomers and diamine monomers, the diacid monomers comprising metal sulfo monomer ranging from about 20 mol % to about 50 mol % of the reaction product and diacids in the range of 15 mol % to about 60 mol % and wherein the diamine monomers comprises about 85 mol % and about 100 mol % of aliphatic diamines and about 0 mol % about 15 mol % cyclo-aliphatic diamines.

28. The water dispersible sulfo-polyamide of claim 27, wherein the metal sulfo monomer comprises 5-sodiosulfoisophthalic acid (SSIPA).

29. The water dispersible sulfo-polyamide 27, wherein the diacids comprise aliphatic diacids and/or aromatic diamides.

30. The water dispersible sulfo-polyamide 29, wherein the aliphatic diacids comprises adipic acid, sebacic acids, dodecanoic acid and combinations thereof.

31. The water dispersible sulfo-polyamide 29, wherein the aromatic diacids comprises isothalic acid, terephthalic acid and combinations thereof.

32. The water dispersible sulfo-polyamide of claim 27, wherein the aliphatic diamines coprise hexamethylenediamine.

32. The water dispersible sulfo-polyamide of claim 27, wherein the cyclo-aliphatic diamines comprise MACM, PACM and combinations thereof.

34. The water dispersible sulfo-polyamide of claim 27 and further comprising lactam in the range of about 0 mol % and about 25 mol % based upon the total mols of the diacid monomers and the diamine monomers.

35. The water dispersible sulfo-polyamide of claim 34 wherein the lactam comprises caprolactam, laurolactam and combinations thereof.
